(19) United States
(12) Patent Application Publication
(10) Pub. No.: US 2026/0265029 A1
(43) Pub. Date: Sep. 10, 2026

(54) SMART DISTRIBUTION VEHICLE AND CONTROL METHOD THEREFOR

(71) Applicants: Hyundai Motor Company, Seoul (KR); Kia Corporation, Seoul (KR)

(72) Inventors: Joo Han KIM, Suwon-si, Gyeonggi-do (KR); Young Jin JUNG, Cheonan-si, Chungcheongnam-do (KR); Yeong Cheol CHO, Suwon-si, Gyeonggi-do (KR); Seon Yeong LEE, Anyang-si, Gyeonggi-do (KR); Do Yeun KIM, Yongin-si, Gyeonggi-do (KR); Hyun Oh LEE, Anyang-si, Gyeonggi-do (KR); Hee Sang YOON, Yongin-si, Gyeonggi-do (KR); Sung Woo HEO, Seongnam-si, Gyeonggi-do (KR)

(73) Assignees: Hyundai Motor Company, Seoul (KR); Kia Corporation, Seoul (KR)

(21) Appl. No.: 18/871,671

(22) PCT Filed: Dec. 20, 2022
(86) PCT No.: PCT/KR2022/020790

§ 371 Date: Dec. 4, 2024

(30) Foreign Application Priority Data
Jun. 7, 2022 (KR) 10-2022-0069076

(51) Int. Cl. B66F 9/06; G05D 1/246; G05D 105/28; G06T 17/00; G06V 20/58

(52) U.S. Cl. CPC B66F 9/063; G05D 1/2465; G06T 17/00; G06V 20/58; G05D 2105/28; G06V 2201/07

(57) ABSTRACT

The smart distribution vehicle control method comprises the steps of: recognizing an object; generating 2D point cloud data on the basis of data output from a 2D sensor, and generating 3D point cloud data on the basis of data output from a 3D sensor; correcting an offset of the 3D point cloud data on the basis of the 2D point cloud data; and determining, on the basis of the corrected 3D point cloud data, the location of a stacked support mounted on the object.

### TECHNICAL FIELD

The present disclosure relates to a smart distribution vehicle that can stably stack pallets, and a method of controlling the smart distribution vehicle.

### RELATED ART

The introduction of smart distribution vehicles is being implemented in general warehouses and factories, as well as in smart factories that manufacture items with different specifications using various parts, to ensure flexible and efficient supply and transportation of parts.

A smart distribution vehicle is a general concept including an Autonomous Mobile Robot (AMR), an Automated Guided Vehicle (AGV), and an automated forklift and these smart distribution vehicles can move and perform tasks under the control of a control system.

A method of stacking pallets in multiple layers can be used in smart factories, etc. to efficiently use the space of warehouses. To this end, a smart distribution vehicle can extract feature lines of the upper end and the lower end of a flat pallet, estimate the location of the pallet based on the extracted feature lines, and stack a loaded pallet at the estimated location of the pallet using a monotype camera, a stereotype camera, or LiDAR.

Unlike flat pallets, in order for a smart distribution vehicle to stack column-type pallets, it is important to accurately determine the location of a stacked support mounted on a column of a column-type pallet.

The description provided above as a related art of the present disclosure is just for helping understand the background of the present disclosure and should not be construed as being included in the related art known by those skilled in the art.

### DISCLOSURE

### Technical Problem

An objective of the present disclosure is to stably stack a column-type pallet loaded on a vehicle onto a stacked support by accurately determining the location of the stacked support mounted on a column of a column-type pallet through 2D and 3D LiDAR sensors.

The technical subjects to implement in the present disclosure are not limited to the technical problems described above and other technical subjects that are not stated herein will be clearly understood by those skilled in the art from the following specifications.

### Technical Solution

In order to achieve the objectives of the present disclosure, a method of controlling a smart distribution vehicle according to an embodiment of the present disclosure may include: recognizing a target; creating 2D point cloud data based on data that is output from a 2D sensor and creating 3D point cloud data based on data that is output from a 3D sensor; correcting an offset of the 3D point cloud data based on the 2D point cloud data; and determining locations of stacked supports mounted on the target based on the corrected 3D point cloud data.

Further, in order to achieve the objectives, a smart distribution vehicle according to an embodiment of the present disclosure may include: a sensing unit including a 2D sensor and a 3D sensor configured to sense a target; a data processor configured to create 2D point cloud data based on data that is output from the 2D sensor, create 3D point cloud data based on data that is output from the 3D sensor, and correct an offset of the 3D point cloud data based on the 2D point cloud data; and a location determiner configured to determine locations of stacked supports mounted on the target based on the corrected 3D point cloud data.

### Advantageous Effects

According to various embodiments of the present disclosure described above, it is possible to stably stack a column-type pallet loaded on a vehicle onto stacked supports by accurately determining the locations of the stacked supports mounted on columns of a column-type pallet through 2D and 3D LiDAR sensors.

The effects that can be obtained by the present disclosure are not limited to the effects described above and other effects can be clearly understood by those skilled in the art from the following description.

### BRIEF DESCRIPTION OF DRAWINGS

FIG. 1 is a block diagram showing an example of the configuration of a smart factory that can be applied to embodiments of the present disclosure.

FIG. 2 is a block diagram showing an example of the configuration of a control system that can be applied to embodiments of the present disclosure.

FIG. 3 is a block diagram showing an example of the configuration of a smart distribution vehicle that can be applied to embodiments of the present disclosure.

FIG. 4 is a perspective view showing an example of the external appearance of a smart distribution vehicle that can be applied to embodiments of the present disclosure.

FIG. 5 is a flowchart showing an example of a driving process of a smart distribution vehicle that can be applied to embodiments of the present disclosure.

FIG. 6 is a block diagram showing an example of the configuration of a smart distribution vehicle according to an embodiment of the present disclosure.

FIG. 7 is a perspective view showing an example of the external appearance of a smart distribution vehicle according to an embodiment of the present disclosure.

FIG. 8 is a view showing an example of a column-type pallet that is loaded/unloaded onto/from a smart distribution vehicle according to an embodiment of the present disclosure.

FIG. 9 is a view showing an example of 3D point cloud data that is created from a 3D LiDAR sensor according to an embodiment of the present disclosure.

FIG. 10 is a view showing an example of 2D point cloud data that is created from a 2D LiDAR sensor according to an embodiment of the present disclosure.

FIG. 11 is a view showing an example of a process of recognizing columns of a column-type pallet based on 2D and 3D point cloud data in an embodiment of the present disclosure.

FIG. 12 is a view showing an example of a process of determining a distance and a rotational angle of stacked supports between column-type pallets in an embodiment of the present disclosure.

FIG. 13 is a flowchart showing a method of controlling a smart distribution vehicle according to an embodiment of the present disclosure.

### MODE FOR INVENTION

Hereafter, embodiments of the present disclosure will be described in detail with reference to the accompanying drawings and the same or similar components are given the same reference numerals regardless of the numbers of figures and are not repeatedly described. Terms “module” and “unit” that are used for components in the following description are used only for the convenience of description without having discriminate meanings or functions. In the following description, if it is decided that the detailed description of known technologies related to the present disclosure makes the subject matter of the embodiments described herein unclear, the detailed description is omitted. Further, the accompanying drawings are provided only for easy understanding the embodiments described herein without limiting the spirit described herein and should be understood as including all of changes, equivalents, and substitutes included in the spirit and scope of the present disclosure.

Terms including ordinal numbers such as “first” and “second” may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element therebetween.

Singular forms are intended to include plural forms unless the context clearly indicates otherwise.

It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

A unit or a control unit included in the internal configuration names of a smart distribution vehicle or a control system is only a term that is generally used to name a controller that controls specific functions rather than mean a generic function unit. For example, each controller may include a modem/transceiver that communicates with another controller or a sensor to control corresponding functions, a memory that stores an operating system or logic commands and input/output information, and one or more processors that perform determination, calculation, decision, etc. for controlling the corresponding functions. Depending on implementation, one processor may be in charge of computation of a plurality of controllers.

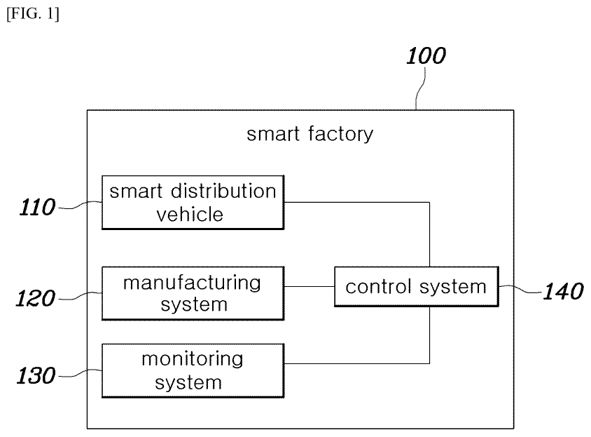

First, the configuration of a smart factory in which a smart distribution vehicle according to an embodiment of deployed and employed is described with reference to FIG. 1.

FIG. 1 is a block diagram showing an example of the configuration of a smart factory that can be applied to embodiments of the present disclosure.

Referring to FIG. 1, a smart factory 100 may include a smart distribution vehicle 110, a manufacturing system 120, a monitoring system 130, and a control system 140.

The smart factor 100 may include a plurality of smart distribution vehicles 110, a plurality of manufacturing systems 120, and a plurality of monitoring systems 130, depending on the manufacturing process and a target manufacturing speed. Hereafter, the components are described.

First, the smart distribution vehicle may include an autonomous mobile robot (hereafter, referred to as an ‘AMR’ for convenience), an automated guided vehicle (hereafter, referred to as an ‘AGV’ for convenience), and an automated forklift. Only one of an AGV or an AMR may be used in accordance with the employment policy of the smart distribution vehicle 110 in the smart factory 100, and an AGV and an AMR both may be operated in a single smart factor 100.

An AGV performs operations (moving, turning, stopping, etc.) that required in the smart factor 100 by recognizing and following guide facilities installed on the floor to guide an AGV. The guide facilities may mean a marker (a spot, a 2D code, etc.) that can be optically recognized, a tag (e.g., an NFC tag, an RFID tag, etc.) that can be recognized in a non-contact type at a short distance, a magnetic strip, a wire, etc., but these are examples and the present disclosure is not necessarily limited thereto. The guide facilities may be continuously disposed or discontinuously spaced apart from each other on a floor. AGVs require that guide facilities have been installed in advance before employment because they basically perform operations by recognizing and following guide facilities, so when it is required to move an AGV to a new path or change an existing path, it is required to install new facilities or physically change existing guide facilities. Further, since AGVs do not depart from a path set through guide facilities, when an obstacle is sensed on or around a path, AGVs generally stop until the object is removed or they are specifically controlled. In order to employ an AGV, the control system 140 should control the AGV based on guide facilities, so the control system 140 can transmit instructions saying ‘drive until recognizing a third marker’, ‘turn 90 degrees when recognizing a third marker’, etc. to the AGV at the current location in the unit of individual instruction or in the unit of a mission including a plurality of instructions (e.g., collecting, supplying, charging, patrolling, etc.)

An AMR can determine the current location (i.e., locationing) by sensing the surroundings and it can be considered as the most distinguishable point from an AGV that an AMR can plan a path (path planning) by itself by locationing and using a map. Accordingly, when a map providing compatible coordinates is shared between an AMR and the control system 140, the control system 140 can control the AMR by giving a path to the AMR based on coordinates. Further, when an obstacle is sensed during driving, an ARM can return after avoiding the obstacle by setting an avoidance path by itself. The function of the control system 140 setting one or more waypoint coordinates as the path of an AMR can be referred to as global path planning and the function of an AMR setting a movement path or an avoidance path between waypoint coordinates determined by global path planning can be referred to as local path planning.

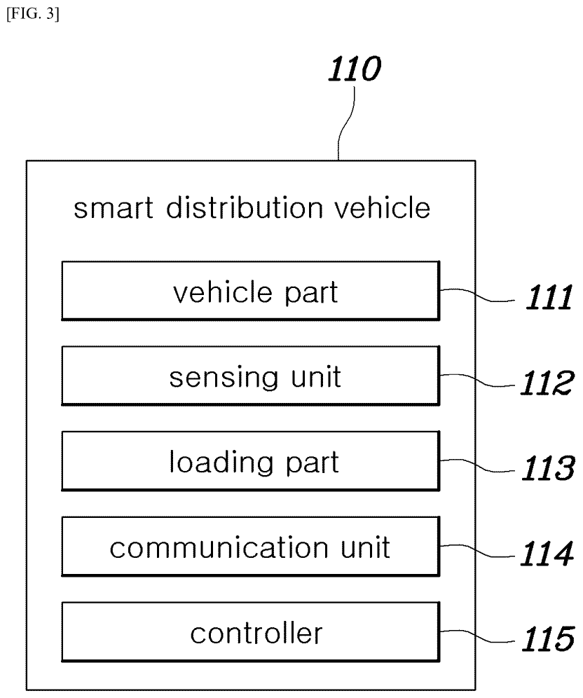

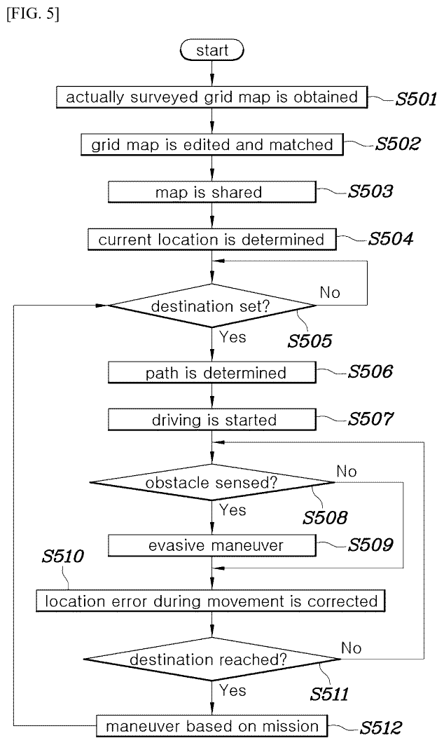

A more detailed configuration of the smart distribution vehicle 110 will be described below with reference to FIG. 3 and FIG. and the driving control process of an AMR will be described below with reference to FIG. 5.

The manufacturing system 120 may mean a system that performs a manufacturing process of products in the smart factory 100 (e.g., a robot arm, a conveyer belt, etc.), and in a broader meaning, may mean a system disposed to assist in execution of missions such as entry and exit of the smart distribution vehicle 110 when a manufacturing process is performed by human. The system for assisting in execution of missions may be a system that monitors the state of a designated location where the smart distribution vehicle 110 can put down pallets carried thereon or can pick pallets in a region in which a specific manufacturing process is performed, a system that determines the status of a process, a system that manages entry and exist in a region, etc., but the system is not limited thereto.

For example, the manufacturing system 120 can be controlled through a Programmable Logic Controller (PLC) and can communicate with the control system 140 in connection with progress of a process.

The monitoring system 130 can perform a function of obtaining information for determining the situation in the smart factory 100 and transmitting the information to the control system 140. For example, the monitoring system 130 may include a camera, a proximity sensor, etc., but is not limited thereto.

The control system 140 communicates with the components 110, 120, and 130 described above, thereby being able to obtain information for employing the smart factory 100 or control the components. For example, the control system 140 can deploy the smart distribution vehicle 110, set a path, allocate a mission, manage a process for each item, manage materials, etc.

In an embodiment, the control system 140 may include a local control system (AMR/AGV Control System (ACS)) that controls surrounding process facilities based on the location of an AGV/AMR and controls the AGV/AMR based on a mission, and an integrated control system (Mobile Robot Integrated Monitoring System (MoRIMS)) that integrally controls two or more local control systems. The integrated control system (MoRIMS) can control the states and paths of all smart distribution robots 110 in the smart factory 100, sets the flow of distribution, and control traffic in cooperation with a plurality of local control systems. For example, when the local control system (ACS) is provided for smart distribution robots of a same manufacturer or a same kind, the integrated control system (MoRIMS) can perform integrated control for preventing a collision such as analysis of a bottleneck level in intersecting/overlapping areas, acceleration/deceleration control in driving, recreation of an avoidance path through traffic distribution control between different kinds based on information obtained through a plurality of local control systems.

Further, the integrated control system (MoRIMS) can also have a Manufacturing Execution System (MES) as an upper control subject and the MES can be liked with an automated scheduler (Advanced Planning & Scheduling (APS).

Other than the components 110, 120, 130, and 140 of the smart factory 100 described above, a device for communication between components such as an Access Point (AP), a charger for charging the smart distribution vehicle 110, a loading space for storing or loading parts, a space where finished products or intermediate products are kept, a traffic signal, a barrier gate, a standby space for resting smart distribution vehicles 110, etc. may also be appropriately disposed in the smart factory 100.

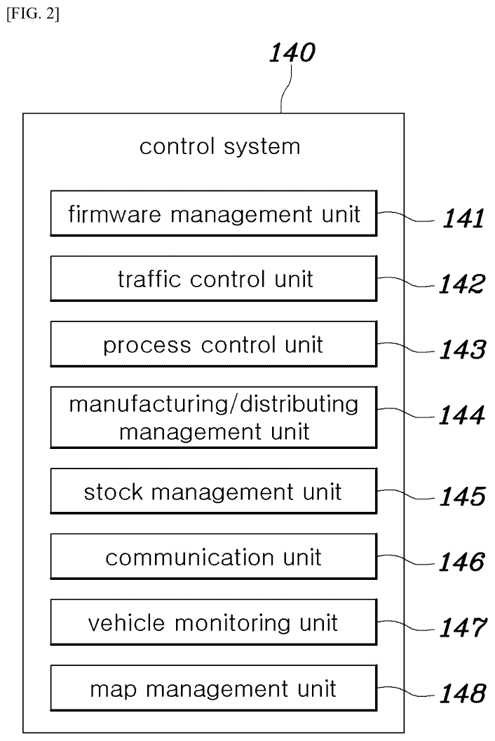

Hereafter, the configuration of the control system 140 that can be applied to embodiments of the present disclosure is described with reference to FIG. 2.

FIG. 2 is a block diagram showing an example of the configuration of a control system that can be applied to embodiments of the present disclosure. The components shown in FIG. 2 are components related to embodiments of the present disclosure, and more or less components may be included to actually implement the control system 140.

Referring to FIG. 2, the control system 140 may include a firmware management unit 141, a traffic control unit 142, a process control unit 143, a manufacturing/distributing management unit 144, a stock management unit 145, a communication unit 146, a vehicle monitoring unit 147, and a map management unit 148.

The firmware management unit 141 obtains newest firmware of the smart distribution vehicle 110 through the communication unit 146 and transmits the newest firmware to a smart distribution vehicle 110 so that firmware is updated, thereby being able to keep the firmware of the smart distribution vehicle 110 up to date.

The traffic control unit 142 can control a traffic signal and a barrier gate based on the path of a smart distribution vehicle 110 and can also re-compute the path of a smart distribution vehicle 110, depending on traffic.

The process management unit 143 can determine a process for each item and can manage missions such as the progress of a process and a progress location.

The manufacturing/distributing management unit 144 can deploy smart distribution vehicles 110 based on missions.

The stock management unit 145 manages the locations and amount of materials and this information can be useful for more efficient employment of processes, for example, by starting a smart distribution vehicle 110 to a destination earlier than the point in time at which materials are actually assembled/consumed to pick up or collect pallets.

The communication unit 146 can communicate with not only internal components of the smart factory 100 such as the smart distribution vehicle 110, the manufacturing system 120, and the monitoring system 130, but other objects such as a firmware update server.

The vehicle monitoring unit 147 can monitor the location, path, battery state, communication state, powertrain state, etc. of individual smart distribution vehicle 110. In this case, the path is a concept including a global path based on way points and a real-time local path. Further, the battery state may include voltage, current, temperature, peak values of voltage and current, State Of Charge (SOC), State Of Health (SOH), etc. The communication state may include information about a currently activated communication protocol (Wi-Fi, etc.), a connected AP, the distance from an AP, a channel being in use, etc. The powertrain state may include load in a driving system, temperature, RPM, etc.

Further, the vehicle monitoring unit 147 can also check the current allocated mission, an operation mode, a firmware version, etc., of individual smart distribution vehicle 110.

The map management unit 148 can obtain map data of a grid map type, which an AMR that is a smart distribution vehicle 110 obtains while driving in the smart factory 100, and can provide a factory manager with a tool enabling the factory manager to edit the obtained map data. It is possible to set zones where a smart distribution vehicle 110 performs one or more preset operations when entering the zone, virtual lanes, intersections, no-entry zones, etc. by editing the map data, but this is an example and the present disclosure is not necessarily limited thereto. The map management unit 148 can distribute the map to smart distribution vehicles 110 other than the smart distribution vehicle 110, which initially obtained the grid map through actual driving, through the communication unit 146.

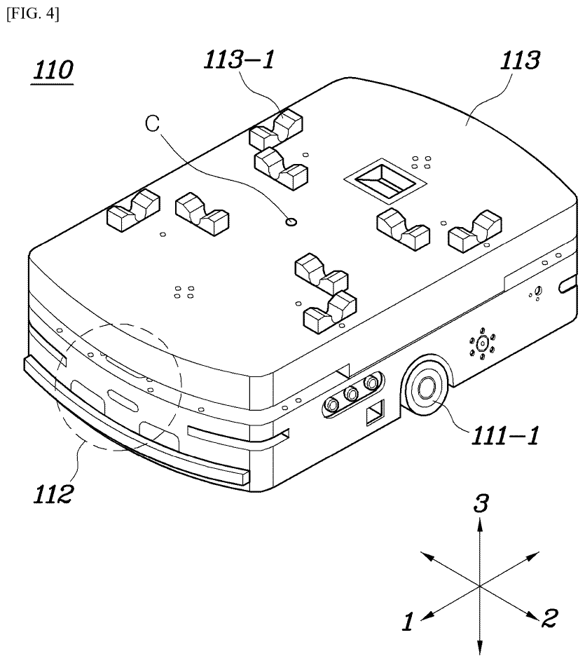

Next, a smart distribution vehicle is described with reference to FIG. 3 and FIG. 4.

FIG. 3 is a block diagram showing an example of the configuration of a smart distribution vehicle that can be applied to embodiments of the present disclosure.

Referring to FIG. 3, the smart distribution vehicle 110 may include vehicle part 111, a sensing unit 112, a loading part 113, a communication unit 114, and a controller 115. Hereafter, the components are described.

The vehicle part 111 may include a driving source, wheels, a suspension, etc. involved with moving, steering, and stopping of the smart distribution vehicle 110. An electric motor that is supplied with power from a built-in battery (not shown) can be used as the driving source. The wheels may include one or more driving wheels that are supplied with driving force from the driving source and non-driving wheels that are rotated by movement of the vehicle body without being supplied with driving force. Depending on embodiments, when a plurality of driving wheels is provided, a driving source can be matched with each of the driving wheels and rotation of the driving wheels can be independently controlled. In this case, it is possible to steer by turning the vehicle body even without a specific steering system by making the rotation directions of different driving wheels different. At least some non-driving wheels may be caster-type wheels, but this is an example and the present disclosure is not necessarily limited thereto.

The sensing unit 112, which is for sensing the environment of the smart distribution vehicle 110, the operation state of the vehicle body, or the like, may include at least one of a 2D laser scanner (e.g., LiDAR), a 3D vision (stereo) camera, a multi-axial gyro sensor, an acceleration sensor, a wheel encoder, and a proximity sensor.

The encoder can output information that makes it possible to determine how much a wheel has rotated using light emitted from a light emitting device (e.g., a photo diode). For example, the encoder can count the number of slits circumferentially disposed on a wheel or a disc rotating with the wheel for a unit time. The controller 115 can perform odometry that estimates displacement by analyzing the amount of location variation to time using data obtained through the encoder and the gyro sensor. However, displacement estimated based on encoder data may be different from actual displacement due to a slip or wear of a wheel (variation of the dynamic radius of a wheel). Accordingly, when performing odometry, the controller 115 can output a result close to an actual value by performing correction for noise and errors through a predetermined algorithm (e.g., an Extended Kalman Filter (EKF)) using information collected from wheels and the gyro sensor. Such odometry may be specifically useful when it is impossible to determine the current location (localization is impossible) using the 2D laser scanner to be described below.

The 2D laser scanner can scan a surrounding environment by emitting a laser to the surroundings through a rotary reflective mirror and sensing a return signal after reflection. In this case, it is possible to output a result of sensing a point cloud shape by analyzing the intensity of the reflected signal and the time difference between emission and reception.

The 3D vision camera can calculate the distance to an object based on a time difference between two cameras spaced a predetermined distance apart from each other, that is, the pixel distance between images taken by the cameras, respectively. A texture projector that emits infrared light with a predetermined pattern may be provided to be able to sense even flat objects with a same color (e.g., white walls).

In general, the 2D laser scanner can be used for mapping, navigation, recognition of objects, etc. and the 3D camera can be used especially to avoid objects in navigation, but this is an example and the present disclosure is not necessarily limited thereto.

The loading part 113, which is a part for loading items to be carried, may be the top plate itself on the vehicle body, a table disposed on the top plate, a lift, a turn table that turns on a vertical shaft, a forklift, a conveyer, or a combination thereof. The forklift may support telescopic and tilting functions similar to common forklifts.

The communication unit 114 can communicate with other components in the smart factory 100 such as the manufacturing system 120 and the control system 140, can support even communication between smart distribution vehicles 110, and can communicate even with a charger when the mission of charging is performed.

The controller 115, which is a subject that generally controls the components 111, 112, 113, and 114 described above, can determine a current mission, a current location, and a destination, plan a path, control the loading part, etc. based on information obtained from the control system 140 through the communication unit 114.

FIG. 4 is a perspective view showing an example of the external appearance of a smart distribution vehicle that can be applied to embodiments of the present disclosure.

Referring to FIG. 4, an exemplary AMR is shown in as a smart distribution vehicle 110. The vehicle body entirely may have a track-type flat shape having a long shaft extending in a first axial direction. One driving wheel 111-1 may be disposed at the center portion of the vehicle body in the first axial direction and may be disposed on a side in a second axial direction, and another driving wheel (not shown) may be disposed on another side opposite to the one driving wheel 111-1 in the second axial direction. This arrangement of driving wheels may be referred to a ‘differential drive (DD)’. Though not shown in FIG. 4, two or more non-driving wheels may be disposed under the vehicle body. In this case, when two driving wheels are rotated in the same direction at the same speed, the vehicle can be moved forward or backward in the first axial direction, and when they are rotated in opposite directions at the same speed, the vehicle can be rotated around a rotation axis extending in a third axial direction and passing through the center C of the plane of the vehicle body. The sensor unit 112 may be disposed on the front of the vehicle body and the loading part 113 may be disposed on the top of the vehicle body. The loading part 113 may be configured to be movable up and down in the third axial direction and a rack or a tray can be fixed on the top by guides 113-1.

However, the configuration of the AMR shown in FIG. 4 described above is an example and it is apparent that an AGV may have a similar configuration or an AMR may have another configuration.

Next, a driving process of a smart distribution vehicle 110 is described with reference to FIG. 5.

FIG. 5 is a flowchart showing an example of a driving process of a smart distribution vehicle 100 that can be applied to embodiments of the present disclosure. It is assumed in FIG. 5 that a smart distribution vehicle 110 is an AMR that can perform localization and local path setting for convenience.

Referring to FIG. 5, first, an AMR can obtain an actually-surveyed grid map through LiDAR, etc. while driving in the smart factory 100 (S501).

When the AMR transmits the obtained grid map to the control system 140, editing and matching of the grid map can be performed in the map management unit 148 of the control system 140 (S502). The editing may include a process of setting various zones described above onto the grid map and a process of assigning a cost to each grid. The closer to an obstacle or a no-entry zone, the higher the cost can be assigned to prevent the AMR from moving around an obstacle or moving to a zone that the AMR is not supposed to enter. This is because the AMR selects a set of cells with a lowest cost between waypoints as a path when setting a local path.

Further, matching of a map may mean a process of matching coordinates between a CAD map used for designing the smart factory 100, an actually-surveyed map (LiDAR map), and an edited topology map.

Thereafter, the control system 140 can share the topology map with all of AMRs in the factory through the communication unit 146 (S503).

The other following steps may be processes that are applied to individual AMRs.

The AMR can determine the current location (localization) on the map using the sensor data of the sensing unit 112 and the obtained map (S504). For example, the AMR can determine the current location by comparing surrounding topographical features obtained through LiDAR and the map based on feature points.

The control system 140 can select a specific AMR and assign a mission to the AMR, and a mission, in generally, can be assigned with one or more waypoints determined through global path planning. A waypoint can be defined by coordinates on a map and can be accompanied with information about a direction (i.e., heading direction) in which the AMR is supposed to move at the coordinates. As such a mission is assigned, a destination can be set in the AMR (Yes in S505), and the AMR can perform local path planning between waypoints based on the costs on the topology map (S506).

When a path is determined, the AMR starts to driving (S507), and when an obstacle is sensed through the sensing unit 112 during driving (Yes in S508), the AMR can perform an evasive maneuver by searching for a local path for avoiding the sensed obstacle. In some cases, the control system 140 may change the mission of the AMR in accordance with the evasive maneuver or failure of the evasive maneuver.

Further, the AMR may correct location errors in movement through the odometry technique described above while driving until reaching the destination (S510).

Thereafter, when reaching the destination (S511), the AMR can perform mission-based maneuvers (S512). For example, the AMR can determine whether conditions for entering a specific process area have been cleared, or collect empty pallets at the destination, or unload the objects loaded on the loading part 113.

An embodiment of the present disclosure proposes a smart distribution vehicle that can stably stack a column-type pallet loaded on the vehicle onto a stacked support by accurately determining the location of the stacked support mounted on a pallet.

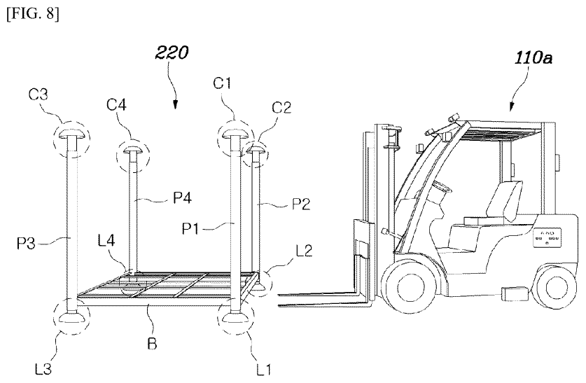

The pallet may be a column-type pallet and the stacked support may be a cup-kit mounted on the column-type pallet. In this case, the smart distribution vehicle can stably stack column-type pallets by accurately determining the locations of cup-kits mounted on columns of the column-type pallets through 2D and 3D LiDAR sensors. Further, a column-type pallet may mean a pallet that has columns vertically extending at corners of a common flat pallet and has cup-kits respectively disposed at the upper end and the lower end of each of the columns and helping maintain a stacked state. A more detailed shape will be described below with reference to FIG. 8.

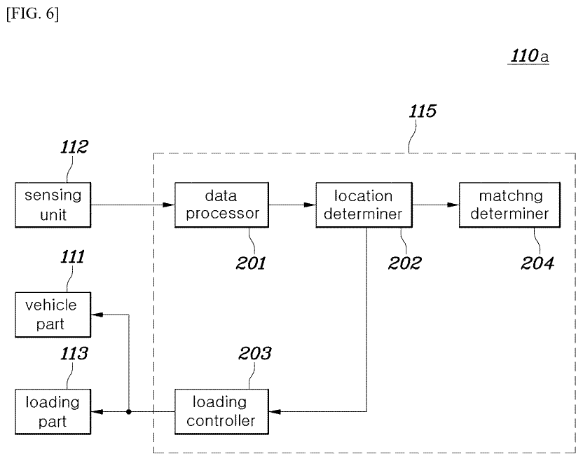

Hereafter, a smart distribution vehicle according to an embodiment is described with reference to FIG. 6.

FIG. 6 is a block diagram showing an example of the configuration of a smart distribution vehicle according to an embodiment of the present disclosure.

Referring to FIG. 6, a smart distribution vehicle 110a may include a vehicle part 111, a sensing unit 112, a loading part 113, and a controller 115, and the controller 115 may include a data processor 201, a location determiner 202, a loading controller 203, and a matching determiner 204. Hereafter, the components are described.

The sensing unit 112 may include at least one 2D LiDAR sensor, 3D LiDAR sensor, and vision sensor for sensing target objects (column-type pallets) around the smart distribution vehicle 110a. The 2D LiDAR sensor can scan the columns of a column-type pallet into 2D shape and the 3D LiDAR sensor can scan a column-type pallet into 3D shape by 3-dimensionally emitting a laser. The 3D LiDAR sensor can generally monitor the shape of a column-type pallet and the 2D LiDAR sensor can more precisely sense the locations of the columns of a column-type pallet in comparison to the 3D LiDAR sensor. The vision sensor may be implemented as an RGB image sensor.

The loading part 113 may be implemented as a forklift loading objects to be carried (column-type pallets).

Hereafter, for the convenience of description, a column-type pallet locationed around the smart distribution vehicle 110a is referred to as a ‘first pallet’ and a column-type pallet loaded on the loading part 113 of the smart distribution vehicle 110a is referred to as a ‘second pallet’.

The data processor 201 can output point cloud data for determining the locations of stacked supports mounted on the columns of the first pallet based on data that is output from the 2D LiDAR sensor, the 3D LiDAR sensor, and the vision sensor.

First, the data processor 201 can create 2D point cloud data based on data that is output from the 2D LiDAR sensor and can create 3D point cloud data based on data that is output from the 3D LiDAR sensor. Further, the data processor 201 can recognize the first pallet through a preset recognition algorithm based on data that is output from the vision sensor. When not recognizing the first pallet, the data processor 201 can keep receiving data from the sensing unit 112.

When recognizing the first pallet based on data that is output from the vision sensor, the data processor 201 can preprocess 2D and 3D point cloud data to remove noise of data. Further, the data processor 201 can transform the coordinates of the location of the first data, which the preprocessed 2D and 3D point cloud data show, based on the location of the smart distribution vehicle 110a. Accordingly, the 2D and 3D point cloud data each can include the coordinates of the location of the first pallet based on the location of the smart distribution vehicle 110a.

Since the 2D LiDAR sensor more precisely sense the locations of the columns of a column-type pallet in comparison to the 3D LiDAR sensor, the data processor 201 can correct an offset of the 3D point cloud data based on the 2D point cloud data. In more detail, referring to Equation 1, the data processor 201 can determine the coordinates a, b, c of the columns of the first pallet based on 2D point cloud data, and can correct the coordinates of the columns of the first pallet, which 3D point cloud data shows, by a preset radius R from an x-axis, a y-axis, and a z-axis based on the coordinates a, b, c of the columns of the first pallet.

$${( x - a )}^{2} + {( y - c )}^{2} + {( z - c )}^{2} = {R}^{2} \qquad Equation 1$$

The location determiner 202 can determine the locations of the stacked supports mounted on the columns of the first pallet based on the corrected 3D point cloud data. In more detail, the location determiner 202 can recognize the columns of the first pallet based on the 3D point cloud data and can compute the coordinates of the locations of the stacked supports mounted on the columns of the first pallet based on the recognition result. Further, the location determiner 202 can determine the distances and rotational angles (degree of twist) between the stacked supports of the first pallet and the loading part 113 based on the locations of the stacked supports of the first pallet and the location of the smart distribution vehicle 110a.

The loading controller 203 controls movement and rotation of the vehicle part 111 and lifting and shifting of the loading part 113 based on the distances and rotational angles between the stacked supports of the first pallet and the loading part, thereby being able to control the location of the loading part 113 with the second pallet loaded thereon.

The matching determiner 204 can compute the distances and rotational angles of the stacked supports of the first pallet and the stacked supports of the second pallet and can determine whether the stacking locations are matched based on the computing result.

When it is determined that the stacking locations are not matched, the loading controller 203 controls movement and rotation of the vehicle part 111 and lifting and shifting of the loading part 113 based on the distances and rotational angles between the stacked supports until determining that the stacking locations are matched, thereby being able to control the location of the loading part 113 with the second pallet loaded.

When it is determined that the stacking locations are matched, the loading controller 203 can perform control such that the second pallet loaded on the loading part 113 is stacked on the stacked supports of the first pallet.

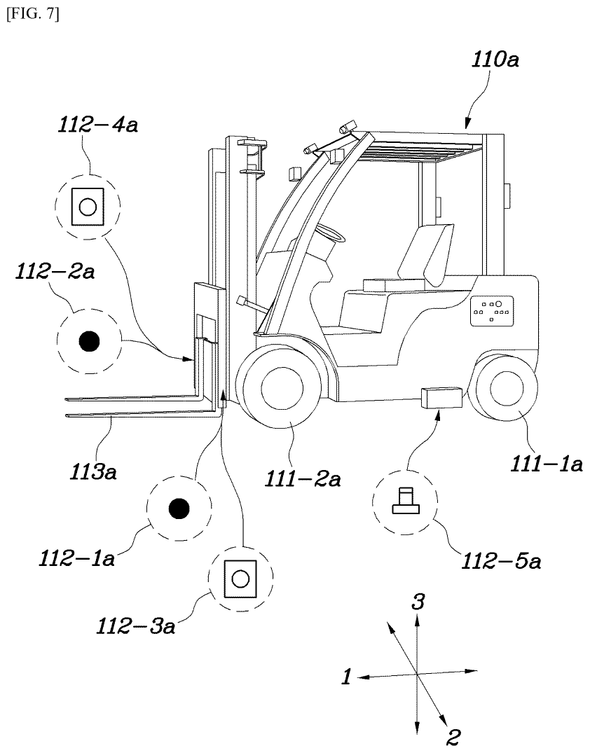

FIG. 7 is a perspective view showing an example of the external appearance of a smart distribution vehicle according to an embodiment of the present disclosure.

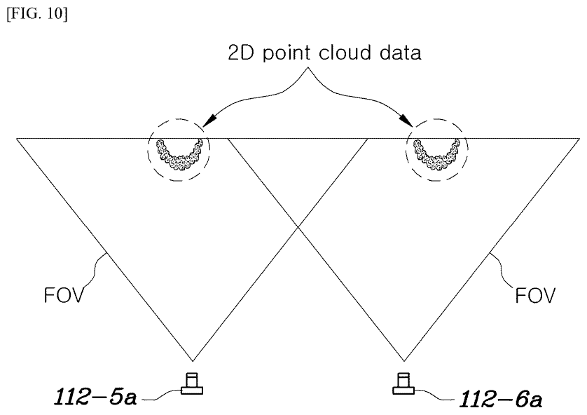

Referring to FIG. 7, an exemplary automated forklift is shown as the smart distribution vehicle 110a. The vehicle body entirely may have a shape having a long shaft extending in a first axial direction. Wheels 111-1a and 111-2a may be disposed on a side of the vehicle body in a second axial direction and other wheels (not shown) may be disposed on another side of the vehicle body to be opposite to the wheels 111-1a and 111-2a in a second axial direction. A fork 113a is disposed on the front of the vehicle body in first axial direction and can perform operations for shifting and lifting a load. Meanwhile, a bar-shaped mechanical switch (not shown) for maintaining a uniform loading location of loads may be mounted on the fork 113a. 3D LiDAR sensors 112-1a and 112-2a and vision sensors 112-3a and 112-4a can be fixed by sensor fixing members (not shown) mounted on the fork 113a. The 3D LiDAR sensors 112-1a and 112-2a and the vision sensors 112-3a and 112-4a can be moved with the sensor fixing members in accordance with shifting and lifting of the fork 113a. The 3D LiDAR sensor 112-1a and the vision sensor 112-3a may be disposed at the left side of the center of the fork 113a, and the LiDAR sensor 112-2a and the vision sensor 112-4a may be disposed at the right side of the center of the fork 113a. One 2D LiDAR sensor 112-5a may be disposed at the center portion of one side of the vehicle body in a second axial direction and another 2D LiDAR sensor (112-6a in FIG. 10) may be disposed at the center portion of another side of the vehicle body in the second axial direction to be opposite to the 2D LiDAR sensor 112-5a.

However, the configuration of the automated forklift shown in FIG. 7 described above is an example and may have another configuration.

FIG. 8 is a view showing an example of a column-type pallet that is loaded/unloaded onto/from a smart distribution vehicle according to an embodiment of the present disclosure.

Referring to FIG. 8, a column-type pallet 220 may include column supports L1~L4, columns P1~P4 connected to the column supports L1~L4, respectively, stacked supports C1~C4 mounted on the upper ends of the columns P1~P4, respectively, and a body B connected at corners to the lower end of the columns P1~P4, respectively. The column supports L1~L4 and the stacked supports C1~C4 may be implemented as cup-kits. Accordingly, the smart distribution vehicle 110a unloads the column supports L1~L4 of one column-type pallet loaded on the loading part 113 onto the stacked supports C1~C4 mounted on another column-type pallet, thereby being able to stacking column-type pallets in multiple layers.

However, the configuration of the column-type pallet shown in FIG. 8 described above is an example and may have another configuration.

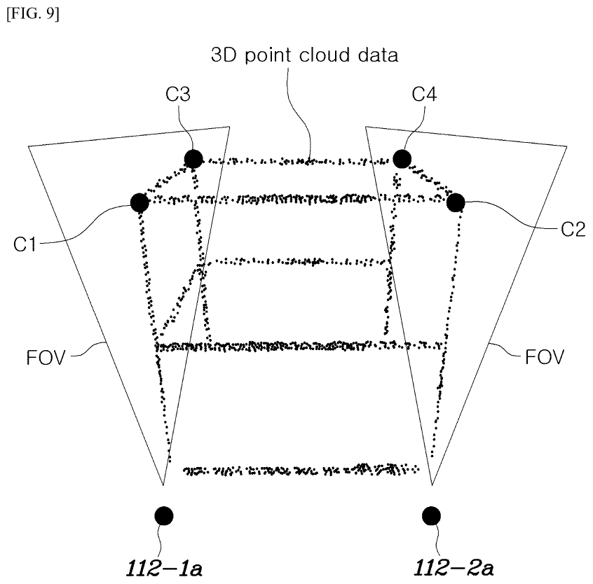

FIG. 9 is a view showing an example of 3D point cloud data that is created from a 3D LiDAR sensor according to an embodiment of the present disclosure.

Referring to FIG. 9, 3D point cloud data shows a general shape including stacked supports C1~C4 of a column-type pallet. 3D LiDAR sensors 112-1a and 112-2a each have a Field of View (FOV) and can estimate the locations of stacked supports C1~C4 using 3D point cloud data in the region of the FOV.

FIG. 10 is a view showing an example of 2D point cloud data that is created from a 2D LiDAR sensor according to an embodiment of the present disclosure.

Referring to FIG. 10, the 2D LiDAR sensor 112-6a may be disposed at the center portion of another side of a vehicle body to be opposite to the 2D LiDAR sensor 112-5a in the second axial direction in FIG. 7. The 2D LiDAR sensors 112-5a and 112-6a each have an FOV and 2D point cloud data shows the columns of a column-type pallet into a 2D shape.

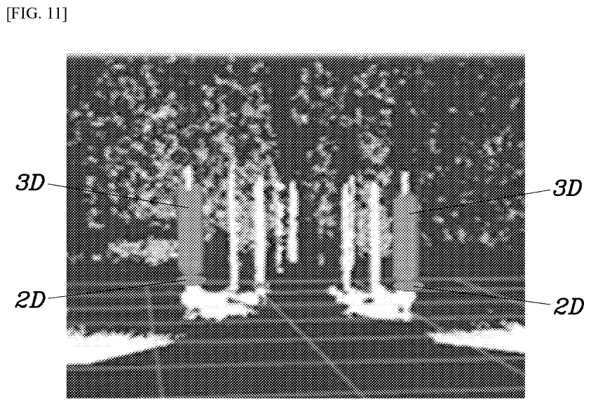

FIG. 11 is a view showing an example of a process of recognizing columns of a column-type pallet based on 2D and 3D point cloud data in an embodiment of the present disclosure.

Referring to FIG. 11, a ‘2D’ region is the result of recognizing the columns of a column-type pallet based on 2D point cloud data created from the 2D LiDAR sensors 112-5a and 112-6a. A ‘3D’ region is the result of recognizing the columns of a column-type pallet based on 3D point cloud data created from the 3D LiDAR sensors 112-1a and 112-2a. Accordingly, the location determiner 202 can accurately determine the location of stacked supports mounted on the columns of a column-type pallet based on recognition results in ‘2D’ and ‘3D’ regions.

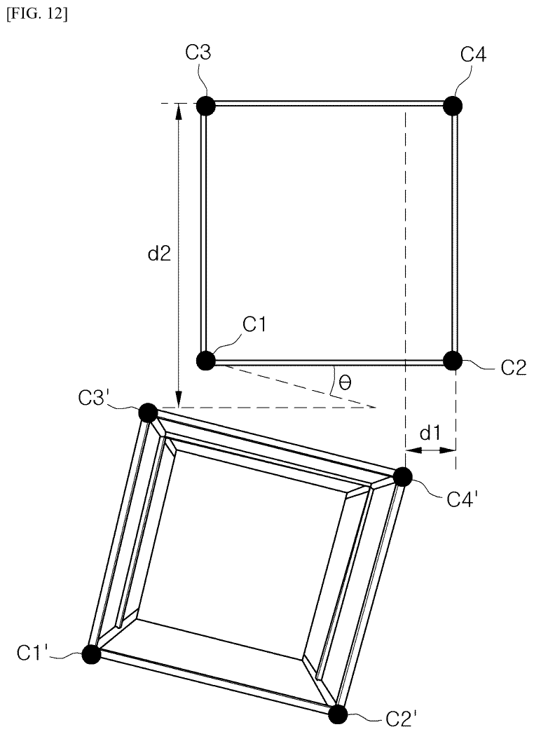

FIG. 12 is a view showing an example of a process of determining a distance and a rotational angle of stacked supports between column-type pallets in an embodiment of the present disclosure.

Referring to FIG. 12, stacked supports C1~C4 are mounted on the columns of a first pallet locationed around the smart driving vehicle 110a and stacked supports C1′~C4′ are mounted on the columns of a second pallet loaded on the loading part 113 of the smart driving vehicle 110a. The stacked supports C1~C4 correspond to the stacked supports C1′~C4′, respectively. The matching determiner 204 can compute the horizontal distances d1, vertical distances d2, and rotational angles θ between the stacked supports C1~C4 of the first pallet and the stacked supports C1′ ~ C4′ of the second pallet.

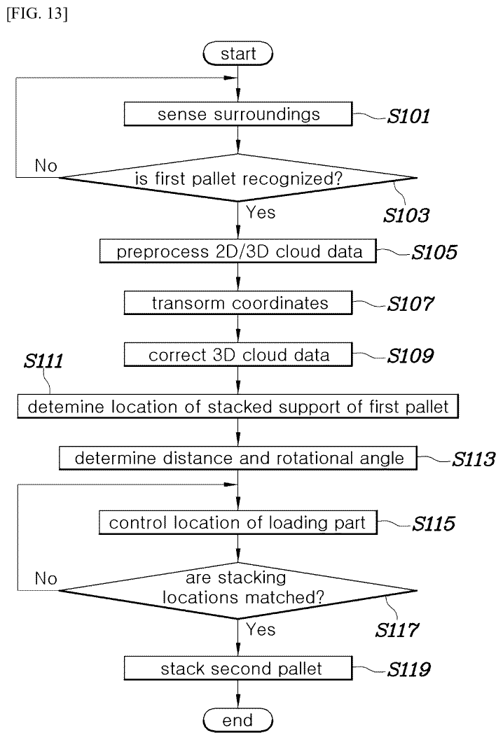

FIG. 13 is a flowchart showing a method of controlling a smart distribution vehicle according to an embodiment of the present disclosure.

Referring to FIG. 13, the 2D LiDAR sensors 112-5a and 112-6a, the 3D LiDAR sensors 112-1a and 112-2a, and the vision sensors 112-3a and 112-4a of the sensing unit 112 can monitor the surroundings of the smart distribution vehicle 110a (S101). In this case, the data processor 201 can create 2D point cloud data based on data that is output from the 2D LiDAR sensors 112-5a and 112-6a and can create 3D point cloud data based on data that is output from the 3D LiDAR sensors 112-1a and 112-2a.

The data processor 201 can determine whether a first pallet has been recognized based on data that is output from the vision sensors 112-3a and 112-4a (S103). When the first pallet has not been recognized (NO in S103), the sensing unit 112 can keep monitoring the circumstance (S101).

When the first pallet has been recognized (YES in S103), the data processor 201 can preprocess the 2D and 3D point cloud data (S105) and can transform the coordinates of the location of the first pallet, which the preprocessed 2D and 3D point cloud data show, based on the location of the smart distribution vehicle 110a (S107).

Thereafter, the data processor 201 can correct an offset of the 3D point cloud data based on the 2D point cloud data (S109). As described above, the data processor 201 can determine the coordinates of columns of the first pallet based on the 2D point cloud data and can correct the coordinates of the columns of the first pallet, which the 3D point cloud data show, by a preset radius R from an x-axis, a-axis, and a z-axis based on the coordinates of the columns of the first pallet.

The location determiner 202 can determine the locations of the columns of the first pallet based on the corrected 3D point cloud data and can determine the locations of stacked supports mounted on the columns of the first pallet based on the recognition result (S111).

When determining the locations of the stacked supports of the first pallet, the location determiner 202 can determine the distances and rotational angles between the stacked supports of the first pallet and the loading part 113 (S113) and the loading controller 203 can control the location of the loading part 113 based on the distances and rotational angles between the stacked supports of the first pallet and the loading part 113 (S115).

The matching determiner 204 can compute the distances and rotational angles of the stacked supports of the first pallet and the stacked supports of the second pallet loaded on the loading part 113 and can determine whether the stacking locations are matched based on the computing result (S117). When it is determined that the stacking locations are not matched (NO in S117), the loading controller 203 can control the location of the loading part 113 based on the distances and rotational angles between the stacked supports (S115).

When it is determined that the stacking locations are matched (YES in S117), the loading controller 203 can perform control such that the second pallet loaded on the loading part 113 is stacked on the stacked supports of the first pallet.

Meanwhile, the present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage. Accordingly, the detailed description should not be construed as being limited in all respects and should be construed as an example. The scope of the present disclosure should be determined by reasonable analysis of the claims and all changes within an equivalent range of the present disclosure are included in the scope of the present disclosure.

### DESCRIPTION OF REFERENCE NUMERALS

| | |
|---|---|
| 100: smart factory | 110: smart distribution vehicle |
| 120: manufacturing system | 130: monitoring system |
| 140: control system | |

1. A method of controlling a smart distribution vehicle, the method comprising:
recognizing a target;
creating 2D point cloud data based on data that is output from a 2D sensor and creating 3D point cloud data based on data that is output from a 3D sensor;
correcting an offset of the 3D point cloud data based on the 2D point cloud data; and
determining locations of stacked supports mounted on the target based on the corrected 3D point cloud data.

2. The method of claim 1, wherein the recognizing comprises:
monitoring surroundings through a vision sensor; and
recognizing the target based on data that is output from the vision sensor, and
the method further comprises preprocessing the 2D and 3D point cloud data when recognizing the target.

3. The method of claim 1, wherein the 2D and 3D point cloud data each include coordinates of a location of the target based on location of the smart distribution vehicle.

4. The method of claim 1, wherein the correcting comprises:
determining coordinates of columns of the target based on the 2D point cloud data; and
correcting the coordinates of the target, which the 3D point cloud data shows, by a preset radius based on the coordinates of the columns of the target.

5. The method of claim 1, wherein the determining comprises:
recognizing columns of the target based on the corrected 3D point cloud data; and
determining coordinates of locations of the stacked supports mounted on the columns of the target based on the recognition result.

6. The method of claim 1, further comprising controlling a location of a loading part with a carried object loaded thereon based on the stacked supports mounted on the target.

7. The method of claim 6, further comprising determining distances and rotational angles between the stacked supports of the target and stacked supports of the carried object, and determining whether stacking locations are matched based on the determination result.

8. The method of claim 7, wherein the controlling of a location is performed such that a location of the loading part is controlled based on the distances and the rotational angles between the stacked supports when it is determined that the stacking location are not matched.

9. The method of claim 7, further comprising performing control such that the carried object is stacked on the stacked supports of the target when it is determined that the stacking locations are matched.

10. A computer-readable recording medium having a program for executing the method of controlling a smart distribution vehicle of claim 1.

11. A smart distribution vehicle comprising:
a sensing unit including a 2D sensor and a 3D sensor configured to sense a target;
a data processor configured to create 2D point cloud data based on data that is output from the 2D sensor, create 3D point cloud data based on data that is output from the 3D sensor, and correct an offset of the 3D point cloud data based on the 2D point cloud data; and
a location determiner configured to determine locations of stacked supports mounted on the target based on the corrected 3D point cloud data.

12. The smart distribution vehicle of claim 11, wherein the sensing unit further comprises a vision sensor configured to sense the target, and
the data processor is further configured to recognize the target based on data that is output from the vision sensor, and preprocess the 2D and 3D point cloud data when recognizing the target.

13. The smart distribution vehicle of claim 11, wherein each of the 2D and 3D point cloud data includes coordinates of a location of the target based on location of the smart distribution vehicle.

14. The smart distribution vehicle of claim 11, wherein the data processor is further configured to determine coordinates of columns of the target based on the 2D point cloud data, and correct coordinates of the target, which the 3D point cloud data shows, by a preset radius based on the coordinates of the columns of the target.

15. The smart distribution vehicle of claim 11, wherein the location determiner is further configured to recognize columns of the target based on the corrected 3D point cloud data, and determine coordinates of locations of the stacked supports mounted on the columns of the target based on the recognition result.

16. The smart distribution vehicle of claim 11, further comprising a loading controller configured to control a location of a loading part with a carried object loaded thereon based on the stacked supports mounted on the target.

17. The smart distribution vehicle of claim 16, further comprising a matching determiner configured to determine distances and rotational angles between the stacked supports of the target and stacked supports of the carried object, and determine whether stacking locations are matched based on the determination result.

18. The smart distribution vehicle of claim 17, wherein the loading controller controls a location of the loading part based on the distances and the rotational angles between the stacked supports when the stacking locations are not matched.

19. The smart distribution vehicle of claim 17, wherein the loading controller performs control such that the carried object is stacked on the stacked supports of the target when the stacking locations are matched.
